(19) United States
(12) Patent Application Publication
(10) Pub. No.: US 2015/0154398 A1
(43) Pub. Date: Jun. 4, 2015

(54) OPTIMIZING VIRUS SCANNING OF FILES USING FILE FINGERPRINTS

(71) Applicant: International Business Machines Corporation, Armonk, NY (US)

(72) Inventors: Carl E. Jones, Tucson, AZ (US); Sapan J. Maniyar, Pune (IN); Sarvesh S. Patel, Maharashtra (IN); Subhojit Roy, Pune (IN)

(73) Assignee: International Business Machines Corporation, Armonk, NY (US)

(21) Appl. No.: 14/094,877

(22) Filed: Dec. 3, 2013

(51) Int. Cl. G06F 21/56

(52) U.S. Cl. CPC G06F 21/561

(57) ABSTRACT

In a method for determining if a file should be scanned for malware before a deduplication process, receiving an indication that a first file is stored or modified to a computing system. The one or more processors create a fingerprint for the first file. The one or more processors determine that the fingerprint for the first file is not already stored in a repository of one or more stored fingerprints, and in response, scan the first file to determine whether the first file is infected with malware. The one or more processors, in response to determining that the first file is not infected with malware, initiate a deduplication process for the first file. The one or more processors store the fingerprint of the first file to the repository of one or more stored fingerprints.

### FIELD OF THE INVENTION

The present invention relates generally to anti-virus software, and more particularly to optimizing virus scanning of files using file fingerprints.

### BACKGROUND OF THE INVENTION

Network-attached storage (NAS) is file-level computer data storage connected to a computer network. A NAS server functions to store computer files, such as documents, sound files, photographs, movies, images, databases, etc., that can be accessed by other computing devices that are connected to the same network. NAS servers may use data deduplication to compress data and eliminate duplicate copies of repeating data. Data deduplication reduces the amount of storage for a given set of data. Data deduplication can also be applied to network data transfers to reduce the amount of data that must be sent.

Malicious software, or malware, is software used to disrupt computer operation, gather sensitive information, or gain access to private computer systems. A computer virus is a type of malware that, when executed, replicates by inserting copies of itself into computer programs, data files, or the hard drive of a computer. Anti-virus software can be installed in a system and can detect and eliminate known viruses when a computer in the system attempts to download or run an infected program.

### SUMMARY

Aspects of embodiments of the present invention disclose a method, computer program product, and computer system for determining if a file should be scanned for malware before a deduplication process. The method includes receiving an indication that a first file is stored or modified to a computing system, wherein the computing system is a part of a distributed data processing environment. The method further includes one or more processors creating a fingerprint for the first file. The method further includes the one or more processors determining that the fingerprint for the first file is not already stored in a repository of one or more stored fingerprints. The method further includes the one or more processors, in response to determining that the fingerprint for the first file is not already stored in the repository of one or more stored fingerprints, scanning the first file to determine whether the first file is infected with malware. The method further includes the one or more processors, in response to determining that the first file is not infected with malware, initiating a deduplication process for the first file. The method further includes the one or more processors storing the fingerprint of the first file to the repository of one or more stored fingerprints.

### BRIEF DESCRIPTION OF THE SEVERAL VIEWS OF THE DRAWINGS

FIG. 1 is a functional block diagram illustrating a distributed data processing environment, in accordance with one embodiment of the present invention.

FIG. 2 is a flowchart depicting operational steps of a fingerprint program for determining if a file will undergo virus scanning prior to deduplication, executing within the environment of FIG. 1, for determining if a received file will undergo virus scanning prior to deduplication, in accordance with one embodiment of the present invention.

FIG. 3 is a functional block diagram illustrating a distributed data processing environment, in accordance with another embodiment of the present invention.

FIG. 4 is a flowchart depicting operational steps of a virus scanning program for determining if a file will undergo virus scanning prior to deduplication, executing within the environment of FIG. 1, for determining if a received file will undergo virus scanning prior to deduplication, in accordance with another embodiment of the present invention.

FIG. 5 depicts a block diagram of components of the server computers of FIG. 1 and FIG. 3, in accordance with embodiments of the present invention.

### DETAILED DESCRIPTION

When a file is uploaded to a NAS server computer, the file usually undergoes a virus scan. A virus scan report is created for the file after the virus scan is complete. In any given distributed data environment, a file may be uploaded to the NAS server computer more than once. If a file is uploaded to the NAS server more than once, the file undergoes a virus scan each time it is uploaded to the NAS server. Embodiments of the present invention recognize that scanning the same file for viruses more than once increases the network traffic of a distributed data environment. If, for example, a file is a duplicate file that was previously scanned and stored, it would not be necessary to scan the duplicate file.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

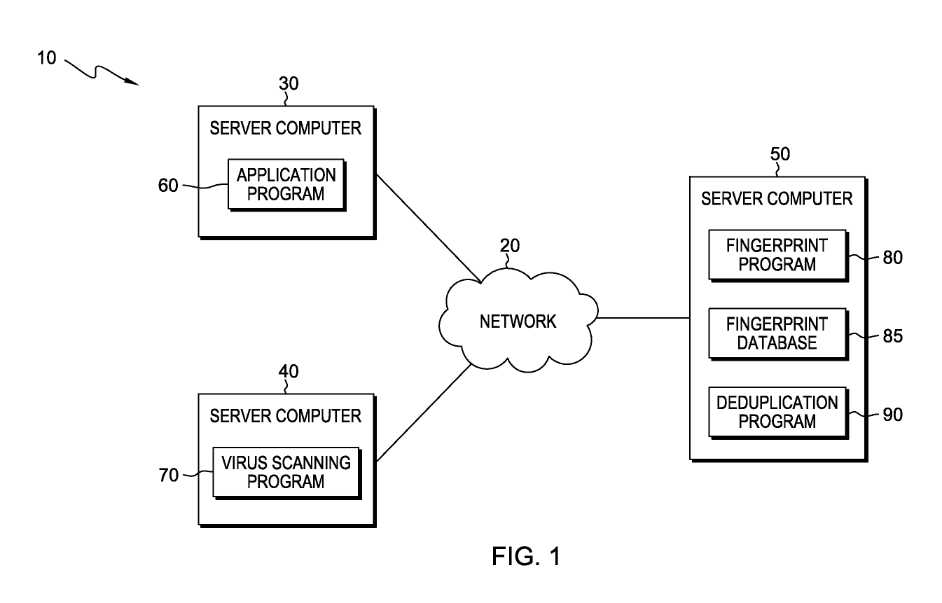

The present invention will now be described in detail with reference to the Figures. FIG. 1 depicts a diagram of distributed data processing environment 10 in accordance with one embodiment of the present invention. FIG. 1 provides only an illustration of one embodiment and does not imply any limitations with regard to the environments in which different embodiments may be implemented.

Distributed data processing environment 10 includes server computer 30, server computer 40, and server computer 50, interconnected over network 20. Network 20 may be a local area network (LAN), a wide area network (WAN) such as the Internet, a combination of the two or any combination of connections and protocols that will support communications between server computer 30, server computer 40, and server computer 50 in accordance with embodiments of the present invention. Network 20 may include wired, wireless, or fiber optic connections. Distributed data processing environment 10 may include additional server computers, client computers, or other devices not shown.

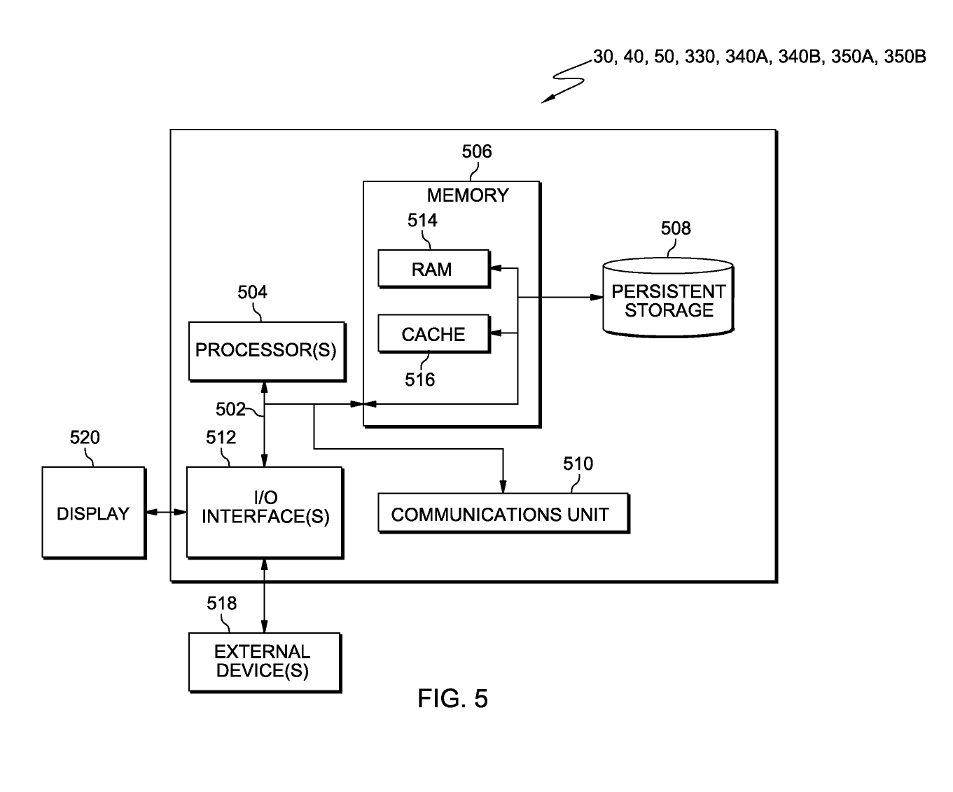

Server computer 30 is an application server. In other embodiments, server computer 30 may be a management server, a web server, or any other electronic device or computing system capable of receiving and sending data. In another embodiment, server computer 30 may represent a server computing system utilizing multiple computers as a server system, such as in a cloud computing environment. In the depicted embodiment, server computer 30 includes application program 60. In one embodiment, server computer 30 includes components described in reference to FIG. 5.

Server computer 40 is an anti-virus server. In other embodiments, server computer 40 may be a management server, a web server, or any other electronic device or computing system capable of receiving and sending data. In another embodiment, server computer 40 may represent a server computing system utilizing multiple computers as a server system, such as in a cloud computing environment. In the depicted embodiment, server computer 40 includes virus scanning program 70. In one embodiment, server computer 40 includes components described in reference to FIG. 5.

Server computer 50 is an NAS file server. A NAS server functions to store computer files, such as documents, sound files, photographs, movies, images, databases, etc., that can be accessed by other computing devices that are connected to the same network. In other embodiments, server computer 50 may be a management server, a web server, or any other electronic device or computing system capable of receiving and sending data. In another embodiment, server computer 50 may represent a server computing system utilizing multiple computers as a server system, such as in a cloud computing environment. In the depicted embodiment, server computer 50 includes fingerprint program 80, fingerprint database 85, and deduplication program 90. In one embodiment, server computer 50 includes components described in reference to FIG. 5.

Application program 60 operates to store or modify files on server computer 50 over network 20. A file may be a document, sound file, photograph, movies, image, database, etc. In the depicted embodiment, application program 60 executes on server computer 30. In other embodiments, application program 60 may operate on another server, computer, or computing device within distributed data processing environment 10, provided that application program 60 has access to server computer 50.

Virus scanning program 70 is anti-virus software that operates to scan files to detect malware. Malware may include computer viruses, spyware, etc. In the depicted embodiment, virus scanning program 70 executes on server computer 40. In other embodiments, virus scanning program 70 operates on another server, computer, or computing device (not shown) within distributed data processing environment 10, provided that virus scanning program 70 has access to server computer 50.

In the depicted embodiment, virus scanning program 70 receives a scan request from server computer 50 over network 20. In the depicted embodiment, the scan request includes a file path for a file to be scanned. After receiving the scan request, virus scanning program 70 scans the file to detect malware.

In one embodiment, virus scanning program 70 uses signature based detection to detect malware. A signature is a code that is unique to each known virus. Virus scanning program 70 compares the contents of the file to a database (not shown) of known virus signatures. Virus scanning program 70 determines if any of the contents of the file exactly match any known virus signatures stored in the database. If virus scanning program 70 determines that a file includes a virus signature, virus scanning program 70 determines that the file is infected with malware.

In another embodiment, virus scanning program 70 uses heuristic-based detection to detect malware. Virus scanning program 70 compares the contents of the file to a database (not shown) of known virus signatures. Virus scanning program 70 determines if any of the contents of the file partially match any known virus signatures stored in the database. If virus scanning program 70 determines that the file includes a content that partially matches a known virus signature, virus scanning program 70 determines that the file is infected with malware. In yet another embodiment, virus scanning program 70 uses another detection method to detect malware.

After virus scanning program 70 scans a file for malware, virus scanning program 70 creates a virus scan report. In one embodiment, a virus scan report is a simple pass/fail report that indicates whether or not the file includes malware. In another embodiment, a virus scan report is a detailed report that highlights any content within the file that matches or partially matches a known virus scan. Virus scanning program 70 sends the virus scan report to fingerprint program 80 over network 20.

Fingerprint program 80 operates to create fingerprints for files stored or modified on server computer 50 and determines if the fingerprint of the file already exists. Fingerprint program 80 also operates to receive virus scan reports from virus scanning program 70, and to send a deduplication request to deduplication program 90. A deduplication request may include the file name and the fingerprint of a file stored or modified on server computer 50. In the depicted embodiment, fingerprint program 80 executes on server computer 50. In other embodiments, fingerprint program 80 operates on another server, computer, or computing device (not shown) within distributed data processing environment 10, provided that fingerprint program 80 has access to server computer 50, virus scanning program 70, fingerprint database 85, and deduplication program 90.

Fingerprint program 80 determines a fingerprint for a file stored or modified on server computer 50. A fingerprint is a sequence that identifies a file and its contents. A fingerprint may include the date and time that the file was stored or modified on server computer 50. In one embodiment, fingerprint program 80 uses an algorithm to create a unique fingerprint to identify each file created or modified on server computer 50.

Fingerprint database 85 is a repository that may be written and read by fingerprint program 80 and deduplication program 90. In one embodiment, fingerprint database 85 is located on server computer 50. In other embodiments, fingerprint database 85 may be located on another system or another computing device within distributed data processing environment 10, provided that fingerprint database 85 is accessible to fingerprint program 80 and deduplication program 90 via network 20. In the depicted embodiment, fingerprint database 85 is a database that stores fingerprints created by fingerprint program 80. Each fingerprint stored by fingerprint database 85 identifies a file stored or modified on server computer 50. Fingerprint database 85 also stores virus scan reports for the files associated with the stored fingerprints.

Deduplication program 90 operates to compress files to eliminate duplicate copies of files and to store the fingerprint of the file to fingerprint database 85. Deduplication program 90 receives a deduplication request from fingerprint program 80. A deduplication request includes the file name of a file stored or modified on server computer 50. The deduplication request may also include the fingerprint of the file stored or modified on server computer 50 if the fingerprint does not already exist on fingerprint database 85. Deduplication program 90 compares the content of the file stored or modified on server computer 50 to content of files previously stored or modified on server computer 50. If deduplication program 90 determines that the content of the file stored or modified on server computer 50 matches content of a previously stored file, deduplication program 90 determines that the file stored or modified on server computer 50 is a duplicate of the stored file. Deduplication program 90 does not save the file stored or modified on server computer 50. Deduplication program 90 stores a reference for the previously stored file.

If deduplication program 90 determines that the content of the file stored or modified on server computer 50 does not match the content of stored files, deduplication program 90 determines that the file stored or modified on server computer 50 is not a duplicate file. Deduplication program 90 saves the file stored or modified on server computer 50 to server computer 50 in a requested location.

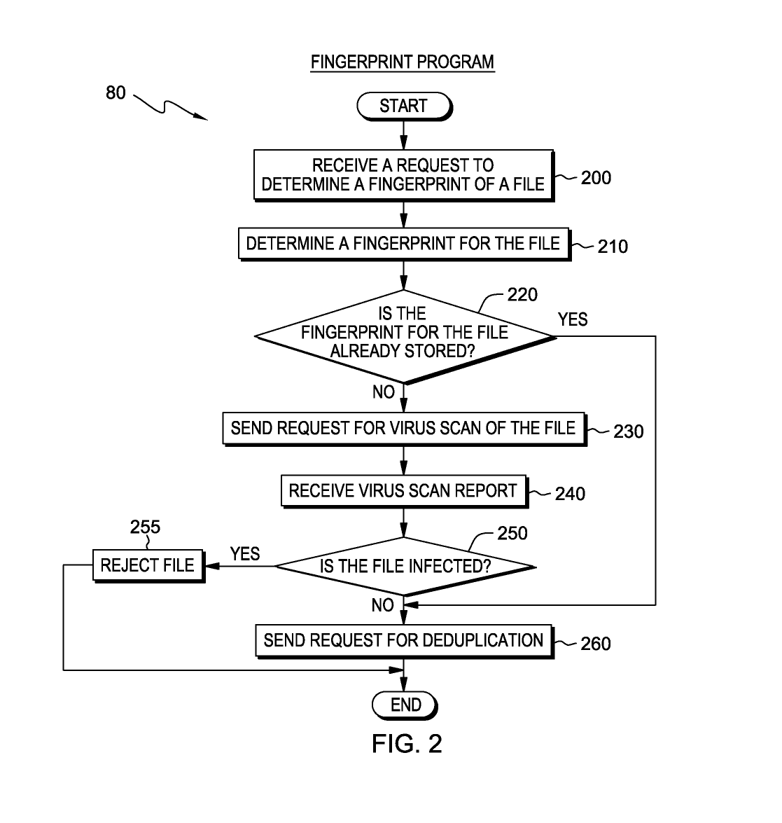

FIG. 2 depicts a flowchart of the steps of fingerprint program 80 for determining if a file will undergo virus scanning prior to deduplication, in accordance with one embodiment of the present invention.

Initially, application program 60 stores a file to server computer 50 over network 20. A file, for example, may be a document. In another example, a file is an image. Software (not shown) on server computer 50 requests that fingerprint program 80 determine a fingerprint for the file stored on server computer 50.

In step 200, fingerprint program 80 receives a request to determine a fingerprint of a file stored or modified on server computer 50. In the depicted embodiment, fingerprint program 80 receives a request from software (not shown) on server computer 50 to determine a fingerprint for a file stored or modified on server computer 50. In another embodiment, fingerprint program 80 receives a request from application program 60. In yet another embodiment, a request can include receiving a file directly from application program 60.

In step 210, fingerprint program 80 determines a fingerprint for the file stored or modified on server computer 50. In one embodiment, fingerprint program 80 uses a cryptographic hash function to create a fingerprint. A cryptographic hash function is an algorithm converts a set of data (i.e. a file) to a fixed-size sequence. The sequence created by the cryptographic hash function is called a hash value. Any change to the original set of data will change the hash value. In another embodiment, fingerprint program uses another method to create a fingerprint.

After creating a fingerprint for the file stored or modified on server computer 50, fingerprint program 80 determines if the fingerprint for the file is already stored in fingerprint database 85 (decision 220). Fingerprint program 80 accesses fingerprint database 85. Fingerprint program 80 compares the fingerprint created in step 210 to the fingerprints stored in fingerprint database 85. Fingerprint program 80 determines if the determined fingerprint matches any of the fingerprints stored in fingerprint database 85. If the determined fingerprint matches a stored fingerprint, fingerprint program 80 proceeds to step 260 (decision 220, Yes branch). In another embodiment, fingerprint program 80 may also request the virus scan report of the file and proceeds to step 260. If the new fingerprint does not match a stored fingerprint, fingerprint program 80 proceeds to step 230 (decision 220, No branch).

In step 230, fingerprint program 80 sends a request for virus scan of the file stored or modified on server computer 50. In the depicted embodiment, fingerprint program 80 sends the scan request to virus scanning program 70 over network 20. The scan request includes the file path for the file stored or modified on server computer 50. Virus scanning program 70 scans the file for malware and creates a virus scan report. Virus scanning program 70 sends the virus scan report for the scanned file to fingerprint program 80 over network 20.

In step 240, fingerprint program 80 receives a virus scan report from virus scanning program 70. In one embodiment, a virus scan report is a simple pass/fail report that indicates whether or not the file includes malware. In another embodiment, a virus scan report is a detailed report that highlights any content within the file that matches or partially matches a known virus scan.

Fingerprint program 80 determines, from the virus scan report, if the scanned file is infected with malware (decision step 250). In one embodiment, the virus scan report includes an indication that the file passed the virus scan and the file is not infected with malware. In another embodiment, the virus scan report includes an indication that the file failed the virus scan and is infected with malware. If the scanned file is infected, fingerprint program 80 proceeds to step 255 (decision 250, Yes branch). In step 255, fingerprint program 80 rejects the file stored or modified on server computer 50. In one embodiment, fingerprint program 80 deletes the file from server computer 50. In another embodiment, fingerprint program 80 sends an indication to application program 60 that the file stored or modified on server computer 50 is infected with malware. For example, fingerprint program 80 sends the virus scan report to application program 60. If the scanned file is not infected, fingerprint program 80 proceeds to step 260 (decision 250, No branch).

In step 260, fingerprint program 80 sends a deduplication request to deduplication program 90. In one embodiment, a deduplication request includes the file name of the file stored or modified on server computer 50. In another embodiment, a deduplication request includes the fingerprint of the file stored or modified on server computer 50. In yet another embodiment, a deduplication request includes sending the file itself to deduplication program 90.

In one embodiment, deduplication program 90 saves the file stored or modified on server computer 50 to a requested location included in the deduplication request. In another embodiment, deduplication program 90 also saves the fingerprint of the file stored or modified on server computer 50 to fingerprint database 85. In yet another embodiment, fingerprint program 80 saves the fingerprint of the file stored or modified on server computer 50 to fingerprint database 85.

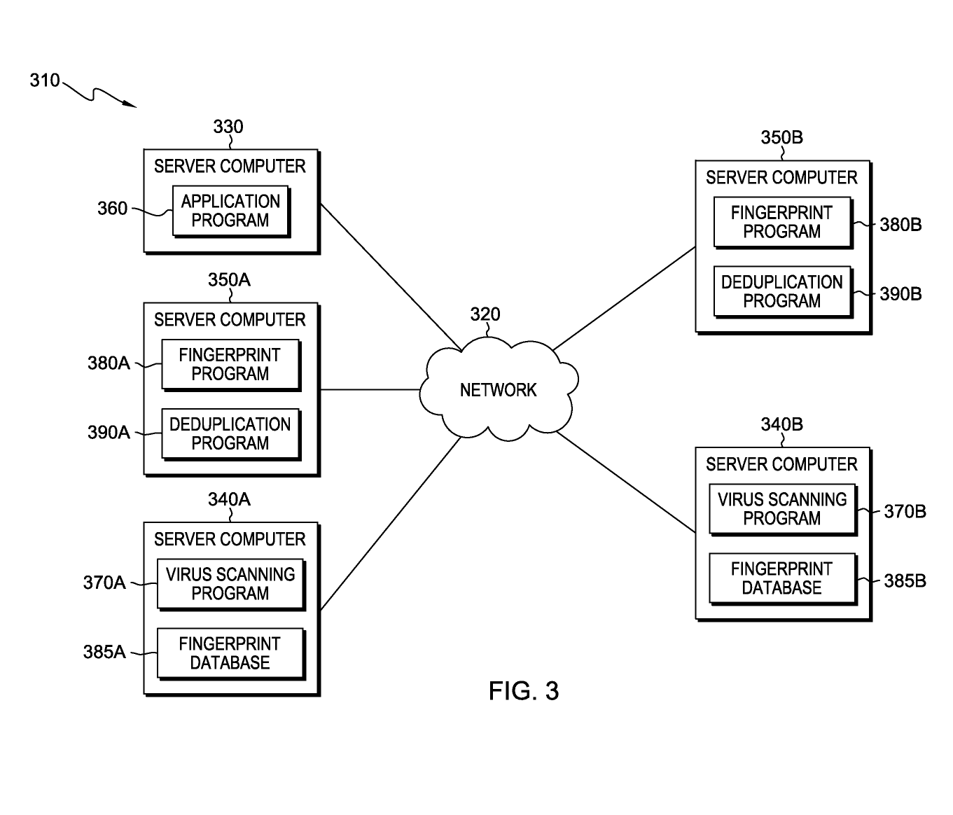

FIG. 3 depicts a diagram of distributed data processing environment 310 in accordance with another embodiment of the present invention. FIG. 3 provides only an illustration of one embodiment and does not imply any limitations with regard to the environments in which different embodiments may be implemented.

Server computer 330 functions the same as server computer 30 as described in reference to FIG. 1. Server computer 340A and server computer 340B (hereinafter referred to as “340A-B”) function the same as server computer 40 as described in reference to FIG. 1. Server computer 350A and server computer 350B (hereinafter referred to as “350A-B”) function the same as server computer 50 as described in reference to FIG. 1. Server computer 330, server computers 340A-B, and server computers 350A-B are connected through network 320. Network 320 functions the same as network 20 as described in reference to FIG. 1.

Application program 360 operates in a similar manner as application program 60 as described in reference to FIG. 1. In the depicted embodiment, application program 360 operates to store or modify files on server computers 340A-B over network 320.

Fingerprint program 380A and fingerprint program 380B (hereinafter referred to as “380A-B”) operate to create fingerprints for files stored or modified on server computers 350A-B, respectively. In one embodiment, fingerprint program 380A receives a request from software (not shown) on server computer 350A to determine a fingerprint for a file stored or modified on server computer 350A. In another embodiment, fingerprint program 380A receives requests to create fingerprints for files stored or modified on server computer 350A, respectively, from application program 360. In yet another embodiment, a request can include receiving a file directly from application program 360.

Fingerprint program 380A sends scan requests to virus scanning program 370A over network 320. In one embodiment, a scan request includes a fingerprint for each file stored or modified on server computer 350A. Fingerprint program 380A receives a virus scan reports from virus scanning program 370A. In one embodiment, after sending scan requests to virus scanning program 370A, fingerprint program 380A sends a deduplication request for the files stored or modified on server computer 350A, respectively, to deduplication program 390A. Fingerprint program 380B operates in a similar manner to fingerprint program 380A but with respect to virus scanning program 370B, and deduplication program 390B.

Deduplication program 390A and deduplication program 390B (hereinafter referred to as “390A-B”) operate to compress files to eliminate duplicate copies of files. Deduplication program 390A receives deduplication requests from fingerprint program 380A. A deduplication request includes the file name of a file stored or modified on server computer 350A. The deduplication request may also include the fingerprint of the file stored or modified on server computer 50 if the fingerprint does not already exist on fingerprint database 385A. Deduplication program 390A compares the content of the file stored or modified on server computer 350A to content of files previously stored or modified on server computer 350A. If deduplication program 390A determines that the content of the file stored or modified on server computer 350A matches content of a previously stored file, deduplication program 390A determines that the file stored or modified on server computer 50 is a duplicate of the stored file. Deduplication program 390A does not save the file stored or modified on server computer 50. Deduplication program 390A stores a reference for the previously stored file.

If deduplication program 390A determines that the content of the file stored or modified on server computer 50 does not match the content of stored files, deduplication program 390A determines that the file stored or modified on server computer 350A is not a duplicate file. Deduplication program 390A saves the file stored or modified on server computer 350A to server computer 350A in a requested location. Deduplication program 390B operates in a similar manner to deduplication program 390A but with respect to server computer 350B and fingerprint program 380B.

Virus scanning programs 370A-B operate to receive scan requests for files stored or modified on server computers 350A-B, respectively, from fingerprint programs 380A-B, respectively. Virus scanning program 370A accesses fingerprint database 385A to determine if the fingerprint included with the scan request is already saved. Virus scanning program 370A operates to determine if the file included in the scan request should be scanned for malware. Virus scanning program 370A can periodically update and sync all fingerprint databases in the distributed data processing environment. Virus scanning program 370B operates in a similar manner to virus scanning program 370A but with respect to server computer 350B, fingerprint program 380B, and fingerprint database 385B.

Fingerprint database 385A is similar to fingerprint database 85 as described in reference to FIG. 1. Fingerprint database 385A is a repository that is similar to fingerprint database 85. Fingerprint database 385A stores fingerprints and virus scan reports. Fingerprint database 385A may be written and read by fingerprint program 380A and deduplication program 390A. Fingerprint database 385B is similar to fingerprint database 385A but with respect to fingerprint program 380B and deduplication program 390B.

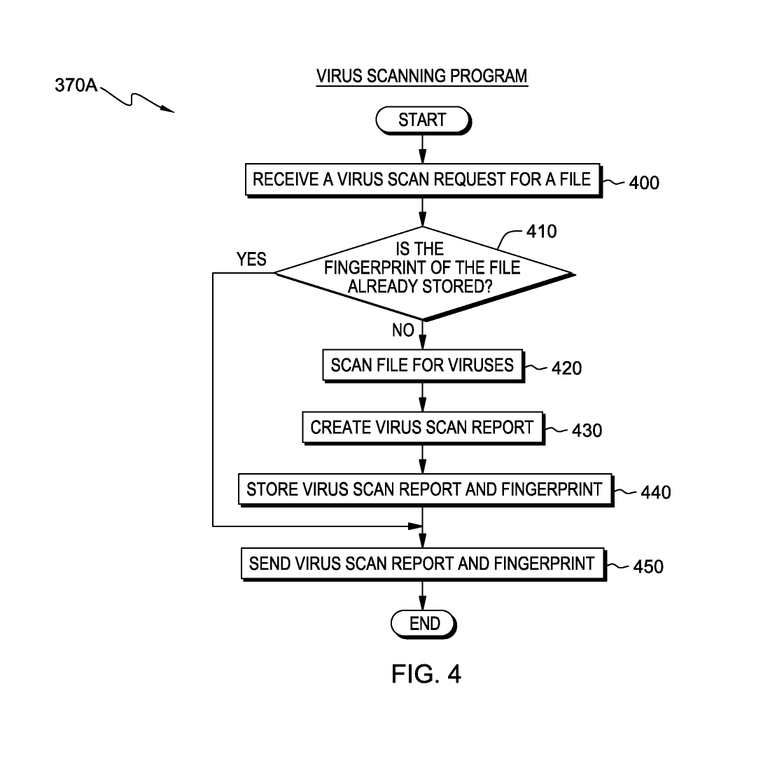

FIG. 4 depicts a flowchart of the steps of virus scanning programs 370A for determining if a file will undergo virus scanning prior to deduplication, in accordance with one embodiment of the present invention.

Initially, in the depicted embodiment, application program 360 stores or modifies a file to server computer 350A over network 320. Fingerprint program 380A receives a request to create a fingerprint for the file. Fingerprint program 380A creates a fingerprint for the file. Fingerprint program 380A sends a scan request to virus scanning program 370A over network 320. A scan request includes a file path and a fingerprint for the file stored or modified on server computer 350A.

In step 400, virus scanning program 370A receives a scan request for a file stored or modified on server computer 350A from fingerprint program 380A over network 320. In one embodiment, the scan request includes a file name and fingerprint of the file stored or modified on server computer 350A.

Virus scanning program 370A determines if the fingerprint of the file stored or modified on server computer 350A is already stored on fingerprint database 385A (decision 410). Virus scanning program 370A accesses fingerprint database 385A. Virus scanning program 370A compares the received fingerprint to the fingerprints stored on fingerprint database 385A. Virus scanning program 370A determines if the fingerprint included with the scan request matches any of the fingerprints stored on fingerprint database 385A. If the received fingerprint matches a stored fingerprint (decision 410, Yes branch), virus scanning program 370A proceeds to step 450. If the received fingerprint does not match a stored fingerprint, virus scanning program 370A proceeds to step 420 (decision 410, No branch).

In step 420, virus scanning program 370A scans the file for malware. In one embodiment, virus scanning program 370A uses signature based detection to detect malware. A signature is a code that is unique to each known virus. Virus scanning program 370A compares the contents of the file to a database (not shown) of known virus signatures. Virus scanning program 370A determines if the content of the file exactly match any known virus signatures stored in the database. If virus scanning program 370A determines that a file includes a virus signature, virus scanning program 370A determines that the file is infected with malware.

In another embodiment, virus scanning program 370A uses heuristic-based detection to detect malware. Virus scanning program 370A compares the contents of the file to a database (not shown) of known virus signatures. Virus scanning program 370A determines if any of the contents of the file partially match any known virus signatures stored in the database. If virus scanning program 370A determines that a file includes a content that partially matches a known virus signature, virus scanning program 370A determines that the file is infected with malware. In yet another embodiment, virus scanning program 370A uses another detection method to detect malware.

In step 430, virus scanning program 370A creates a virus scan report. In one embodiment, a virus scan report is a simple pass/fail report that indicates whether or not the file includes malware. In another embodiment, a virus scan report is a detailed report that highlights any content within the file that matches or partially matches a known virus scan.

In step 440, virus scanning program 370A stores the created virus scan report and fingerprint of the file stored or modified on server computer 350A to fingerprint database 385A.

In step 450, virus scanning program 370A sends the virus scan report to fingerprint program 380A over network 320. Virus scanning program 370A also sends the virus scan report and fingerprint of the file stored or modified on server computer 350A to fingerprint database 385B. Virus scanning program 370A can also send the virus scan report and fingerprint to a plurality of fingerprint databases in the same distributed data processing environment.

FIG. 5 depicts a block diagram of components of server computer 30, server computer 40, and server computer 50 of FIG. 1 in accordance with one embodiment of the present invention. FIG. 5 also depicts a block diagram of components of server computer 330, server computers 340A-B, and server computers 350A-B of FIG. 3 in accordance with one embodiment of the present invention. It should be appreciated that FIG. 5 provides only an illustration of one implementation and does not imply any limitations with regard to the environments in which different embodiments may be implemented. Many modifications to the depicted environment may be made.

Server computer 30, server computer 40, server computer 50, server computer 330, server computers 340A-B, and server computers 350A-B can each include communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Application program 60 is stored in persistent storage 508 of server computer 30 for execution by one or more of the respective computer processors 504 of server computer 30 via one or more memories of memory 506 of server computer 30. Virus scanning program 70 is stored in persistent storage 508 of server computer 40 for execution by one or more of the respective computer processors 504 of server computer 40 via one or more memories of memory 506 of server computer 40. Fingerprint program 80, fingerprint database 85, and deduplication program 90 are each stored in persistent storage 508 of server computer 50 for execution by one or more of the respective computer processors 504 of server computer 50 via one or more memories of memory 506 of server computer 50.

Application program 360 is stored in persistent storage 508 of server computer 330 for execution by one or more of the respective computer processors 504 of server computer 330 via one or more memories of memory 506 of server computer 330. Virus scanning programs 370A-B are stored in persistent storage 508 of server computers 340A-B for execution by one or more of the respective computer processors 504 of server computers 340A-B via one or more memories of memory 506 of server computers 340A-B. Fingerprint programs 380A-B, fingerprint databases 385A-B, and deduplication programs 390A-B are each stored in persistent storage 508 of server computers 350A-B for execution by one or more of the respective computer processors 504 of server computers 350A-B via one or more memories of memory 506 of server computers 350A-B.

In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media capable of storing program instructions or digital information.

The media used by persistent storage 508 may also be removable. For example, a removable hard drive may be used for persistent storage 508. Other examples include optical and magnetic disks, thumb drives, and smart cards inserted into a drive for transfer onto another computer-readable storage medium that is also part of persistent storage 508.

Communications unit 510, in these examples, provides for communications with other servers or devices. In these examples, communications unit 510 includes one or more network interface cards. Communications unit 510 may provide communications through the use of either or both physical and wireless communications links. Application program 60 is stored in persistent storage 508 of server computer 30 for execution by one or more of the respective computer processors 504 of server computer 30 via one or more memories of memory 506 of server computer 30. Virus scanning program 70 is stored in persistent storage 508 of server computer 40 for execution by one or more of the respective computer processors 504 of server computer 40 via one or more memories of memory 506 of server computer 40. Fingerprint program 80, fingerprint database 85, and deduplication program 90 are each stored in persistent storage 508 of server computer 50 for execution by one or more of the respective computer processors 504 of server computer 50 via one or more memories of memory 506 of server computer 50.

Application program 360 is stored in persistent storage 508 of server computer 330 for execution by one or more of the respective computer processors 504 of server computer 330 via one or more memories of memory 506 of server computer 330. Virus scanning programs 370A-B are stored in persistent storage 508 of server computers 340A-B for execution by one or more of the respective computer processors 504 of server computers 340A-B via one or more memories of memory 506 of server computers 340A-B. Fingerprint programs 380A-B, fingerprint databases 385A-B, and deduplication programs 390A-B are each stored in persistent storage 508 of server computers 350A-B for execution by one or more of the respective computer processors 504 of server computers 350A-B via one or more memories of memory 506 of server computers 350A-B.

I/O interface(s) 512 allows for input and output of data with other devices that may be connected to server computer 30, server computer 40, server computer 50, server computers 340A-B, or server computers 350A-B. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., application program 60, can be stored on such portable computer-readable storage media and can be loaded onto persistent storage 508 of server computer 30, respectively, via the respective I/O interface(s) 512 of server computer 30. Software and data used to practice embodiments of the present invention, e.g., virus scanning program 70, can be stored on such portable computer-readable storage media and can be loaded onto persistent storage 508 of server computer 40 via I/O interface(s) 512 of server computer 40. Software and data used to practice embodiments of the present invention, e.g., fingerprint program 80, fingerprint database 85, and deduplication program 90, can be stored on such portable computer-readable storage media and can be loaded onto persistent storage 508 of server computer 50 via I/O interface(s) 512 of server computer 50.

Software and data used to practice embodiments of the present invention, e.g., application program 360, can be stored on such portable computer-readable storage media and can be loaded onto persistent storage 508 of server computer 330, respectively, via the respective I/O interface(s) 512 of server computer 330. Software and data used to practice embodiments of the present invention, e.g., virus scanning programs 370A-B, can be stored on such portable computer-readable storage media and can be loaded onto persistent storage 508 of server computers 340A-B via I/O interface(s) 512 of server computers 340A-B. Software and data used to practice embodiments of the present invention, e.g., fingerprint programs 380A-B, fingerprint databases 385A-B, and deduplication programs 390A-B, can be stored on such portable computer-readable storage media and can be loaded onto persistent storage 508 of server computers 350A-B via I/O interface(s) 512 of server computers 350A-B.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining if a file should be scanned for malware before a deduplication process, the method comprising the steps of:
receiving an indication that a first file is stored or modified to a computing system, wherein the computing system is a part of a distributed data processing environment;
one or more processors creating a fingerprint for the first file;
the one or more processors determining that the fingerprint for the first file is not already stored in a repository of one or more stored fingerprints;
the one or more processors, in response to determining that the fingerprint for the first file is not already stored in the repository of one or more stored fingerprints, scanning the first file to determine whether the first file is infected with malware;
the one or more processors, in response to determining that the first file is not infected with malware, initiating a deduplication process for the first file; and
the one or more processors storing the fingerprint of the first file to the repository of one or more stored fingerprints.

2. The method of claim 1, wherein the indication that the first file is stored or modified to the computing system includes a request to scan the first file for malware.

3. The method of claim 1, further comprising the step of the one or more processors storing the fingerprint of the first file to one or more other repositories of stored fingerprints in the distributed data processing environment.

4. The method of claim 3, further comprising the step of the one or more processors storing a virus scan result of the first file to the repository of one or more stored fingerprints.

5. The method of claim 1, wherein the step of the one or more processors determining that the fingerprint for the first file is not already stored in a repository of one or more stored fingerprints comprises:
the one or more processors accessing the repository of one or more stored fingerprints; and
the one or more processors comparing the fingerprint for the first file to one or more fingerprints already stored in the repository of one or more stored fingerprints.

6. The method of claim 1, further comprising the steps of:
receiving an indication that a second file is stored or modified to the computing system;
the one or more processors creating a fingerprint for the second file;
the one or more processors determining that the fingerprint for the second file is not already stored in the repository of one or more stored fingerprints;
the one or more processors, in response to determining that the fingerprint for the second file is not already stored in the repository of one or more stored fingerprints, scanning the second file to determine whether the second file is infected with malware; and
the one or more processors, in response to determining that the second file is infected with malware, rejecting the second file.

7. The method of claim 1, further comprising the steps of:
receiving an indication that a third file is stored or modified to the computing system;
the one or more processors creating a fingerprint for the third file;
the one or more processors determining that the fingerprint for the third file is already stored in the repository of one or more stored fingerprints; and
the one or more processors, in response to determining that the fingerprint for the third file is already stored in the repository of one or more stored fingerprints, accessing a stored virus scan result for the third file.

8. A computer program product for determining if a file should be scanned for malware before a deduplication process, the computer program product comprising:
one or more computer-readable storage media and program instructions stored on the one or more computer-readable storage media, the program instructions comprising:
program instructions to receive an indication that a first file is stored or modified to a computing system, wherein the computing system is a part of a distributed data processing environment;
program instructions to create a fingerprint for the first file;
program instructions to determine that the fingerprint for the first file is not already stored in a repository of one or more stored fingerprints;
program instructions, in response to determining that the fingerprint for the first file is not already stored in the repository of one or more stored fingerprints, to scan the first file to determine whether the first file is infected with malware;
program instructions, in response to determining that the first file is not infected with malware, to initiate a deduplication process for the first file; and
program instructions to store the fingerprint of the first file to the repository of one or more stores fingerprints.

9. The computer program product of claim 8, wherein the indication that the first file is stored or modified to the computing system includes a request to scan the first file for malware.

10. The computer program product of claim 8, further comprising program instructions, stored on the one or more computer-readable storage media, to store the fingerprint of the first file to one or more other repositories of stored fingerprints in the distributed data processing environment.

11. The computer program product of claim 10, further comprising program instructions, stored on the one or more computer-readable storage media, to store a virus scan result of the first file to the repository of one or more stored fingerprints.

12. The computer program product of claim 8, wherein the program instructions to determine that the fingerprint for the first file is not already stored in a repository of one or more stored fingerprints comprise:
program instructions to access the repository of one or more stored fingerprints; and
program instructions to compare the fingerprint for the first file to one or more fingerprints already stored in the repository of one or more stored fingerprints.

13. The computer program product of claim 8, further comprising:
program instructions, stored on the one or more computer-readable storage media, to receive an indication that a second file is stored or modified to the computing system;
program instructions, stored on the one or more computer-readable storage media, to create a fingerprint for the second file;
program instructions, stored on the one or more computer-readable storage media, to determine that the fingerprint for the second file is not already stored in the repository of one or more stored fingerprints;
program instructions, stored on the one or more computer-readable storage media, in response to determining that the fingerprint for the second file is not already stored in the repository of one or more stored fingerprints, to scan the second file to determine whether the second file is infected with malware; and
program instructions, stored on the one or more computer-readable storage media, in response to determining that the second file is infected with malware, to reject the second file.

14. The computer program product of claim 8, further comprising:
program instructions, stored on the one or more computer-readable storage media, to receive an indication that a third file is stored or modified to the computing system;
program instructions, stored on the one or more computer-readable storage media, to create a fingerprint for the third file;
program instructions, stored on the one or more computer-readable storage media, to determine that the fingerprint for the third file is already stored in the repository of one or more stored fingerprints; and
program instructions, stored on the one or more computer-readable storage media, in response to determining that the fingerprint for the third file is already stored in the repository of one or more stored fingerprints, to access a stored virus scan result for the third file.

15. A computer system for determining if a file should be scanned for malware before a deduplication process, the computer system comprising:
one or more computer processors;
one or more computer-readable storage media;
program instructions stored on the computer-readable storage media for execution by at least one of the one or more processors, the program instructions comprising:
program instructions to receive an indication that a first file is stored or modified to a computing system, wherein the computing system is a part of a distributed data processing environment;
program instructions to create a fingerprint for the first file;
program instructions to determine that the fingerprint for the first file is not already stored in a repository of one or more stored fingerprints;
program instructions, in response to determining that the fingerprint for the first file is not already stored in the repository of one or more stored fingerprints, to scan the first file to determine whether the first file is infected with malware;
program instructions, in response to determining that the first file is not infected with malware, to initiate a deduplication process for the first file; and
program instructions to store the fingerprint of the first file to the repository of one or more stores fingerprints.

16. The computer system of claim 15, wherein the indication that the first file is stored or modified to the computing system includes a request to scan the first file for malware.

17. The computer system of claim 15, further comprising program instructions, stored on the computer-readable storage media for execution by at least one of the one or more processors, to store the fingerprint of the first file to one or more other repositories of stored fingerprints in the distributed data processing environment.

18. The program product of claim 17, further comprising program instructions, stored on the computer-readable storage media for execution by at least one of the one or more processors, to store a virus scan result of the first file to the repository of one or more stored fingerprints.

19. The computer system of claim 15, wherein the program instructions to determine that the fingerprint for the first file is not already stored in a repository of one or more stored fingerprints comprise:
program instructions to access the repository of one or more stored fingerprints; and
program instructions to compare the fingerprint for the first file to one or more fingerprints already stored in the repository of one or more stored fingerprints.

20. The computer system of claim 15, further comprising:
program instructions, stored on the computer-readable storage media for execution by at least one of the one or more processors, to receive an indication that a second file is stored or modified to the computing system;
program instructions, stored on the computer-readable storage media for execution by at least one of the one or more processors, to create a fingerprint for the second file;
program instructions, stored on the computer-readable storage media for execution by at least one of the one or more processors, to determine that the fingerprint for the second file is not already stored in the repository of one or more stored fingerprints;
program instructions, stored on the computer-readable storage media for execution by at least one of the one or more processors, in response to determining that the fingerprint for the second file is not already stored in the repository of one or more stored fingerprints, to scan the second file to determine whether the second file is infected with malware; and
program instructions, stored on the computer-readable storage media for execution by at least one of the one or more processors, in response to determining that the second file is infected with malware, to reject the second file.
